(19) United States
(12) Patent Application Publication
(10) Pub. No.: US 2006/0240144 A1
(43) Pub. Date: Oct. 26, 2006

(54) Biodegradable chewing gum bases

(76) Inventors: Shalaby W. Shalaby, Anderson, SC (US); James M. Lindsey III, Pendleton, SC (US); Kimberly A. Carpenter, Pendleton, SC (US)

Correspondence Address: LEIGH P. GREGORY;ATTORNEY AT LAW, PO BOX 168, CLEMSON, SC, 29633-0168, US

(21) Appl. No.: 11/408,516

(22) Filed: Apr. 21, 2006

Related U.S. Application Data
(60) Provisional application No. 60/673,645, filed on Apr. 21, 2005.

(51) Int. Cl. A23G 4/00

(52) U.S. Cl. 426/3

(57) ABSTRACT

Biodegradable chewing gum bases are provided having natural and/or synthetic polymeric components of polypeptide- and/or polyester-based materials, the bases having modulated hydrophilicity, adhesive properties, compliance, and elasticity.

This application claims the benefit of prior provisional application U.S. Ser. No. 60/673,645, filed Apr. 21, 2005.

### FIELD OF THE INVENTION

The present invention is directed to biodegradable chewing gum base compositions for the production of environmentally friendly chewing gum. Not only do the present inventive compositions biodegrade into safe by-products, but they also are safely ingested, and exhibit bulk and surface properties that minimize the need for the use of texturing agents in the chewing gum formulation.

### BACKGROUND OF THE INVENTION

Modern chewing gum had its beginning in the 1860s when chicle was brought to the United States from Mexico and tried as a chewing gum ingredient. Nowadays, chewing gums are made primarily from gum base, sweeteners, softeners, and flavorings. Most pertinent to this invention is the gum base. The latter puts the “chew” in chewing gum, binding all ingredients together and creating a smooth, soft texture. Historically, gum base was derived from various natural resins, including sorva and jelutong. Scarcity of the natural resins and increased demand for chewing gum led to the development of new, synthetic gum base materials. These new materials allow for longer-lasting flavor, improved texture, and reduced tackiness. Most commonly used gum bases are made of natural and/or synthetic elastomers.

As noted in U.S. Pat. No. 6,194,008, natural elastomers used in conventional gum bases may include natural rubber such as smoked or liquid latex and guayule, natural gum such as jelutong, lechi caspi perillo, massaranduba balate, massaranduba chocolate, nispero, rosidinha, chicle, gutta percha, gutta kataiu, niger gutta, tunu chilte, chiquibul, and gutta hang kang. Synthetic elastomers used in conventional gum bases may include high molecular weight butadiene-styrene copolymers and isobutylene-isoprene copolymers, low- to high-molecular weight polybutadiene, polyisobutylene, polyvinyl acetate, vinyl acetate/vinyl laurate copolymers, vinyl acetate/vinyl stearate copolymers, ethylene/vinyl acetate copolymers, polyvinyl alcohol or mixtures thereof.

Although chewed gum can be easily disposed of without creating any problems, chewed gum when improperly disposed can be environmentally unacceptable. In this regard, the improper disposal of chewed gum, e.g., expectorating the chewed gum on a sidewalk, floor, or like area can create a nuisance. Typically, these gum cuds are mainly composed of a water insoluble masticated part which is represented by the gum base. Due to their formulations, these gum cuds have adhesive-like characteristics. Therefore, the chewed gum cuds can stick to surfaces on to which they are placed, resulting in unacceptable environmental and sanitation situations.

Biodegradable chewing gum entailing a biodegradable gum base would lead to a solution of above-noted problems associated with conventional chewing gums made of non-biodegradable natural and/or synthetic elastomers and resins. Although some natural resins and elastomers such as chicle, jelutong, natural rubber, esters of wood rosin, and polyterpene resins may be still used in gum bases, today synthetic polymers such as styrene-butadiene rubber (SBR), butyl rubber, polyisobutylene and poly(vinyl acetate) are the dominant mastictory substances. Unfortunately, these synthetic polymers are inherently resistant to biodegradation.

In response to the growing need for developing biodegradable gum base, there have been several new disclosures. These included (1) U.S. Pat. No. 5,672,367 which discloses a gum base made of biodegradable polymers selected from a group of polyesters and polycarbonates; (2) U.S. Pat. No. 6,194,008 describing a biodegradable gum base made of polyhydroxyalkanoates having side chain lengths of C₄ to C₃₀; (3) U.S. Pat. No. 6,613,363 which discloses biodegradable chewing gum bases including plasticized poly(dl-lactic acid) and copolymers thereof; (4) U.S. Pat. No. 6,773,730 that deals with ingestible and degradable gum bases comprising hydrolyzed zein; (5) U.S. Pat. No. 6,858,238 which teaches the use of a biodegradable prolamine mixed with a polyester derived from acids such as lactic, glycolic, citric and adipic and/or caprolactone; (6) U.S. Pat. No. 6,441,126 that discloses a gum base comprising at least one aliphatic biodegradable polyester comprising repeat units formed from at least one polyol having 3 to 4 hydroxyl groups; (7) U.S. Pat. No. 6,153,231 which addresses a gum base comprising 3-99% biodegradable polylactic acid copolymer; (8) U.S. Pat. No. 5,580,590 which describes a water insoluble gum base protein that is rendered elastomeric by crosslinking with gamma radiation; and (9) U.S. Pat. No. 5,366,740 that describes a digestible biodegradable chewing gum comprising wheat gluten. In effect, the prior art dealing with the use of biodegradable chewing gum base has attempted to address the previously noted environmental concerns by providing compositions that do not accumulate as they are used and disposed by virtue of being degradable, water-soluble, and yielding safe by-products.

However, U.S. Pat. No. 5,580,590 raised the requirements for the chewing gum to be environmentally friendly without describing compositions that meet fully such requirements in the disclosure. In effect, U.S. Pat. No. 5,580,590 called for limiting the use of the term environmentally friendly to mean chewing gum composition that will degrade, be easily removed from indoor and outdoor surfaces, can be ingested after chewing, and/or dissolve in the mouth after a period of chewing. Relevant to these new requirements, without addressing the biodegradation issue, U.S. patent application Ser. No. 10/604,516 (2005) described an essentially free of non-silica fillers chewing gum composition that produces gum bases and chewing gums having reduced adhesion to outdoor surfaces as compared to typical chewing gum compositions. Prior to setting these requirements, U.S. Pat. No. 5,366,740 emphasized the need for a successful biodegradable chewing gum to contain texturing agents such as calcium carbonate, rice flour, and ascorbic acid.

Upon reviewing the above-noted prior art, it became obvious that all the disclosed compositions of the chewing gum bases did not address the biodegradability of these compositions in conjunction with their contributions to the desirable non-sticking properties of the final chewing gum formulations. This provided a strong incentive to explore the basic tenets of the present invention. And this invention is directed to biodegradable chewing gum base designed to degrade, to be safe to ingest, and minimize the need for texturing agents.

### SUMMARY OF THE INVENTION

This invention deals generally with biodegradable gum bases of natural and/or synthetic polymeric components with modulated hydrophilicity, adhesive properties, compliance, and elasticity. In one embodiment this invention is directed to a biodegradable chewing gum base comprising a combination of a natural polypeptide and a miscible derivative thereof, wherein the polypeptide and its derivatives are of the prolamine type.

In another embodiment the polypeptide is polyaspartic acid, which is synthetic, and its miscible derivative is polysuccinimide partially reacted with mono- or polyfunctional aliphatic amine.

Yet another aspect of this invention deals with a biodegradable chewing gum base which is a polyether ester, wherein the polyether ester is an end-grafted polyethylene glycol, an AB or ABA block copolymer, wherein the A block is polyethylene glycol and the B block is polypropylene glycol, with at least one cyclic monomer selected from the group represented by dl-lactide, l-lactide, glycolide, trimethylene carbonate, ε-caprolactone, p-dioxanone, 1,5-dioxepan-2-one and a morpholinedione. The polyether-ester, having at least one hydroxyl end-group per chain, can be reacted further with itaconic anhydride to produce at least one free radically polymerizable end-group. The polyether ester can be made by reacting a polyalkylene glycol, such as polyethylene glycol or a block copolymer of polyethylene glycol and polypropylene glycol with one or more alkane diol selected from the group represented by the formula HO(CH₂)ₙOH where n=2 to 12 and dimethyl or diethyl oxalate.

Another aspect of this invention deals with a biodegradable chewing gum base which is a crystalline segmented copolyester exhibiting a melting endotherm below 60° C. and a second melting endotherm below 220° C. with an overall heat of fusion of less than 60 J/g, wherein the constituent polyester has at least one hydroxyl group per chain converted to a free radically polymerizable group through reaction with itaconic anhydride. As a preferred alternative, the constituent polyester has at least one hydroxyl group per chain that is interlinked with a polyethylene glycol using lysine diisocyanate as the interlinking agent.

Another key aspect of this invention deals with a biodegradable chewing gum base which is a polysaccharide and a miscible derivative thereof, wherein the polysaccharide is chitosan and its miscible derivative is an acylated chitosan made by reacting it with at least one anhydride selected from acetic anhydride, propionic anhydride, stearic anhydride, 2-alkyl or 2-alkenyl succinic anhydride, succinic anhydride, and itaconic anhydride.

Another aspect of this invention deals with a biodegradable chewing gum base which is a combination of a natural polypeptide and a miscible derivative thereof, wherein the natural peptide is casein and its miscible derivative is an acylated casein made by reacting it with at least one anhydride selected from acetic anhydride, propionic anhydride, stearic anhydride, 2-alkyl or 2-alkenyl succinic anhydride, succinic anhydride, and itaconic anhydride.

Another aspect of this invention deals with a biodegradable chewing gum base which is a combination of a synthetic polypeptide and a miscible derivative thereof, wherein the polypeptide is polyaspartic acid and the miscible derivative is polysuccinimide that is partially reacted with water and an alkylamine and further reacted with calcium hydroxide.

For specific applications, this invention deals with a biodegradable chewing gum base comprising a combination of a synthetic polypeptide and a miscible derivative thereof with modulated hydrophilicity, adhesive properties, compliance, and elasticity, wherein the polypeptide is polyaspartic acid and its miscible derivative is polysuccinimide that is partially reacted with mono- or polyfunctional aliphatic amine. It is preferred that the polypeptide is polyaspartic acid and the miscible derivative is polysuccinimide that is partially reacted with water and an alkylamine and further reacted with calcium hydroxide. The corresponding chewing gum formulations can be used as a tartar barrier agent and to inhibit dental tartar and plaque formations.

### DETAILED DESCRIPTION OF PREFERRED EMBODIMENTS

This invention addresses the unmet contemporary environmental requirements which have been overlooked in the prior art pertaining to conventional chewing gums. More specifically, these contemporary requirements call for chewing gum bases which (1) are inherently biodegradable to allow their conversion to environmentally safe by-products following the disposal of used chewing gum formulations; (2) are safe or degrade to safe by-products if ingested; (3) display optimized surface and bulk properties to avoid sticking to surfaces upon disposal of the used chewing gum formulation and hence, minimize the need for using texturing agents in the formulation; and (4) exhibit other attributes enjoyed by widely used, non-absorbable commercial chewing gum formulations.

The present invention provides improved chewing gum bases that are environmentally friendly by (1) making use of biodegradable natural materials which have been established as being biodegradable and meet the physicomechanical requirements of an ideal system—these include prolamine-type polypeptides such as zein and gluten; (2) modifying biodegradable natural polymers to modulate their properties to meet the aforementioned requirements of an ideal gum base system—these include chitosan and casein; (3) designing synthetic polyester-based systems with structural features to meet the requirements of an ideal chewing gum base—these include end-grafted polyether-glycol with segmented polyester components and then interlinked with urethane linkages, using an aliphatic diisocyanate as the interlinking agent; (4) redesigning certain segmented polyesters that are partially crystalline but highly malleable and chewable—these include segmented polyesters which have both low melting and high melting crystallites with the former being capable of melting during the chewing and the latter to contribute to desirable mechanical integrity and modulated elasticity; (5) using combinations of natural and/or synthetic biodegradable polymers having interactive functional groups to allow for reactive blending to create new biodegradable gum bases with unique physicomechanical properties to meet the requirements of an ideal gum base—these include combinations of modified and/or unmodified chitosan with modified or unmodified prolamine or a polyaspartic acid copolymer; (6) using combinations of modified and/or unmodified natural protein with different net charges such as casein and zein; and (7) incorporating components that release bioactive agents such as antimicrobials and/or are capable of inhibiting dental tartar and plaque formation.

Description of specific examples of modified natural polymers suitable for using as chewing gum bases can be outlined as follows:

1. Acylated Casein and Grafted Products Thereof—Casein is partially acylated with a mixture of acetic anhydride and one or more cyclic anhydrides such as itaconic, glutaric, 2-alkyl or alkenyl succinic anhydride as described for soya protein isolates in U.S. Pat. No. 5,986,050. The acylated protein may be used as such or after grafting with one or more cyclic monomer selected from the group represented by β-caprolactone, trimethylene carbonate, dl-lactide, l -lactide, p-dioxanone, and 1,5-dioxapan-2-one.

2. Acylated Zein and Grafted Products Thereof—These are prepared as described as in the case of acylated casein and its grafted products.

3. Acylated Soya Protein Isolates—These are prepared as described above for their casein counterparts.

4. Acylated Chitosan and Grafted Products Thereof—These are prepared as described for their casein counterparts.

Descriptions of reactive blends of polycationic and polyanionic polyelectrolytes can be outlined as follows:

1. Reactive Blends of Acylated Polycationic Chitosan and Acylated Polyanionic Chitosan—The acylated polycationic chitosan is made by partial acylation of commercial chitosan (90% deacetylated) with a mixture of anhydrides selected from the group represented by acetic, propionic, and stearic anhydride. The acylated polyanionic chitosan is made by extensive acylation of chitosan (more than 50% of available primary amine groups) using at least one cyclic anhydride selected from the group represented by succinic, 2-alkyl succinic, 2-alkenyl succinic, glutaric, and itaconic anhydrides. Alternatively, the polyanionic chitosan is made by acylating the amine groups using a chloroacetic ester followed by hydrolysis. The polycationic and polyanionic acylated chitosans are mixed in a common solvent or plasticized with an organic non-reactive solvent and heated under intensive mixing (in a single or twin screw extruder) to allow their ionic and/or covalent interaction. The resulting product is isolated and used as a biodegradable gum base. Alternatively, the interaction of the polycationic and polyanionic acylated chitosan is conducted in the presence of a polymeric surfactant such as an amphoteric chitosan made by partially acylating chitosan with a cyclic acid anhydride.

2. Reactive Blends of Aspartic Acid/Succinimide Copolymer with Partially Acylated Chitosan—Copolymeric aspartic/succinimide is prepared by the partial hydrolysis of polysuccinimide. The latter is made by the polycondensation of the product of ammonium hydroxide and maleic anhydride or aspartic acid as noted in U.S. Pat. Nos. 5,057,597; 4,839,461; 5,175,285; 6,001,956; and 5,408,028. Polycationic chitosan is prepared by partial acylation of chitosan with at least one anhydride selected from the group represented by acetic, propionic, and stearic anhydride. The reactive blending is carried out following a scheme similar to that described for the reactive blending of polycationic and polyanionic chitosan.

Descriptions of specific examples of synthetic absorbable/biodegradable polymers suitable for use as in chewing gum bases can be outlined as follows:

1. Segmented Polyether Glycols End-grafted with Hydrophobic Polyesters—These are typically prepared by end-grafting one or more liquid or solid polyether glycols having a molecular weight of 400 to 35,000 Dalton selected from the group represented by polyethylene glycol, polypropylene glycol, and block copolymers of polyethylene and polypropylene glycol with at least one cyclic monomer selected from the group represented by ε-caprolactone, lactide, glycolide, trimethylene carbonate, p-dioxanone, 1,5-dioxepan-2-one. The polyether esters can be used as such or after interlinking with an aliphatic diisocyanate such as lysine diisocyanate or hexamethylene diisocyanate.

2. Segmented Copolyester with Distinct Bimodal Crystalline Melting Endotherms—A typical example of these copolyesters is made according to the following scheme: (a) a mixture of 90/10 ε-caprolactone (or trimethylene carbonate) and glycolide (or l-lactide) is polymerized in the presence of trimethylol propane and stannous octanoate as the initiator and catalyst, respectively; and (b) the resulting polymer from this step is end-grafted with a mixture of 80/20 ε-caprolactone (or trimethylene carbonate) and glycolide (or 1-lactide) under conditions to minimize ester-ester interchange and hence, produce partially crystalline end-grafts.

3. Copolymers of Aspartic Acid—To prepare copolymers of aspartic acid that meet the requirements of the successful chewing gum base subject of this invention, the following steps are pursued. First, polysuccinimide is prepared by the condensation of aspartic acid or preferably by condensation of the reaction product of ammonium hydroxide with maleic anhydride (as noted in U.S. Pat. Nos. 5,057,597; 4,839,461; 5,175,285; 6,001,956; and 5,408,208). The polysuccinimide is then reacted with one or more alkylamine, wherein the alkyl group has more than two carbon atoms. Alternatively, the reaction of the polysuccinimide is carried out in the presence of a mixture of at least one alkylamine and at least one aliphatic alcohol, both having an alkyl group having at least two carbon atoms. The aminolysis and alcoholysis steps can also be conducted in the presence of a relatively small amount of water to form a copolymer with more carboxylic side groups.

Further illustrations of the present invention are provided by the following examples:

### EXAMPLE 1

### Preparation of Segmented Polyaxial 80/20 Caprolactone (CL)/Glycolide (G) Copolymer (80/20 S-CG)

The preparation of 80/20 S-CG is pursued in two steps following the general protocol for producing polyaxial copolyesters described in U.S. Pat. No. 6,462,169. Thus, a polymeric initiator is made by ring-opening polymerization of caprolactone (0.9 mole) and glycolide (0.1 mole) in the presence of trimethylol propane (2 mmole) and stannous octanoate (0.055 mmole, as a 0.2 M solution in toluene) as the primary initiator and catalyst, respectively. The polymerization is conducted at 160° C. for 1.2 hours and a second charge of glycolide (0.02 mole) is added while stirring. The stirring is continued for about 20 minutes. The temperature of the polymerization charge is then lowered to 140° C. and the reaction is continued for an additional 7 hours. The cooled polymer is isolated, ground, dried, and characterized for molecular weight (in terms of inherent viscosity using hexafluoro isopropyl alcohol as a solvent) and two thermal transitions below 60° C. and 200° C. as well as heat of fusion (Tₘ₁, Tₘ₂ and ΔH_{f} by DSC).

### EXAMPLE 2

### Synthesis of 65-35 (Weight Percent)(93/7 Caprolactone/Glycolide) Glycolide Polymer

The reaction apparatus was a 1L stainless steel kettle with a 3-neck glass lid equipped with an overhead mechanical stirring unit, a bearing assembly, and two 90° connectors for a nitrogen inlet. After obtaining a vacuum of 0.05 mmHg, the apparatus was placed under positive nitrogen pressure. An initial charge consisting of 483.0 grams (4.2369 moles) of ε-caprolactone, 37.0 grams (0.3189 moles) glycolide, 1.44 grams (9.11×10⁻³ moles) decyl alcohol, and 1.162 milliliters (2.323×10⁻⁴ moles) of a 0.2M solution of tin (II) 2-ethylhexanoate in toluene was added to the kettle

Using a high temperature oil bath, the apparatus was placed under vacuum at 40° C. for 1 hour. The system was then purged with nitrogen. The temperature of the oil bath was increased to 160° C. and stirring was initiated at 60 rpm. As the contents gained viscosity, the stir rate was lowered to 30 rpm then to 10 rpm. After approximately 4.5 hours, the temperature of the oil bath was decreased to 60° C. and stirring was stopped. Contents were kept at 60° C. overnight. Temperature of the oil bath was then increased to 110° C. After approximately 20 minutes at 110° C., the second charge of 280 g (2.4138 moles) of glycolide was added to the kettle. Two hours after the second charge was added, the temperature was increased to 130° C. After 15 minutes at 130° C., the temperature was increased to 160° C. After 1 hour at 160° C., the temperature was increased to 200° C. After 30 minutes at 200° C., the temperature was decreased to 180° C. After 1 hour at 180° C., the temperature was decreased to 160° C. The reaction was maintained at 160° C. for 7 hours.

The polymer was ground and placed under room temperature vacuum overnight. The ground polymer was poured into a 1L stainless steel kettle with a 3-neck glass lid equipped with 2 stoppers and a 90° connector. After obtaining a vacuum of 0.15 mmHg, the kettle and its contents were heated to 40° C. using a high temperature oil bath. After 1 hour at 40° C., the temperature of the oil bath was increased to 60° C. and maintained for 45 minutes. The temperature was then increased to 80° C. and maintained for 1.25 hours. The temperature was then increased to 110° C. and maintained for 4 hours. (NOTE: After approximately 2.5 hours at 110° C., the 90° connector was replaced with a distillation neck and 2-neck boiling flask equipped with a 90° connector to help with monomer removal.) The kettle and its contents were then allowed to cool under vacuum before removal of polymer.

The inherent viscosity using hexafluoroisopropanol as a solvent was 1.86 dl/g. Differential scanning calorimetry showed a peak at 42.3° C. with an area of 19 J/g and a peak at 209.2° C. with an area of 40.9 J/g.

### EXAMPLE 3

### Synthesis of 60-40 (Weight Percent)(90/10 Caprolactone/Glycolide)—(90/10 Glycolide/Caprolactone) Polymer

The reaction apparatus was a 1L stainless steel kettle with a 3-neck glass lid equipped with an overhead mechanical stirring unit, a bearing assembly, and two 90° connectors for a nitrogen inlet. After obtaining a vacuum of 0.1 mmHg, the apparatus was placed under positive nitrogen pressure. An initial charge consisting of 323.4 grams (2.8371 moles) of ε-caprolactone, 36.6 grams (0.3152 moles) glycolide, 1.423 grams (9.01×10⁻³ moles) decyl alcohol, and 0.581 milliliters (2.323×10⁻⁴ moles) of a 0.2M solution of tin (II) 2-ethylhexanoate in ε-caprolactone was added to the kettle

Using a high temperature oil bath, the apparatus was placed under vacuum at 40° C. for 1 hour. The system was then purged with nitrogen. The temperature of the oil bath was increased to 160° C. and stirring was initiated at 60 rpm. As the contents gained viscosity (˜25% increase in torque), the stir rate was lowered to 30 rpm. Once the torque increased by ˜25% at 30 rpm, the second charge consisting of 23.6 g (0.2073 moles) of ε-caprolactone, 0.29 milliliters (5.81×10⁻⁵ moles) of a 0.2M solution of tin (II) 2-ethylhexanoate in ε-caprolactone, and 216.4 g (1.8653 moles) of glycolide was added to the kettle while stirring at 30 rpm. Stir rate was then increased to 60 rpm. Stirring was gradually decreased and stopped approximately 45 minutes after the second charge was added. The reaction was maintained at 160° C. for 9 hours after stirring was stopped.

The polymer was ground and placed under room temperature vacuum overnight. The ground polymer was poured into a 2L pear shaped glass flask and then placed on a Buchi rotavapor. After obtaining vacuum of 0.15 mmHg, the flask and its contents were heated to 40° C. using a high temperature oil bath. After 2 hours at 40° C., the temperature of the oil bath was increased to 80° C. and maintained for 1 hour. The temperature was then increased to 110° C. and maintained for 4 hours. The flask and its contents were then allowed to cool under vacuum before removal.

The inherent viscosity using hexafluoroisopropanol as a solvent was 1.26 dl/g. Differential scanning calorimetry showed a peak at 39.5° C. with an area of 16.2 J/g and a peak at 211.2° C. with an area of 36 J/g.

### EXAMPLE 4

### Synthesis of 60-40 (weight percent) (92/8 Caprolactone/Glycolide)—Glycolide Polymer

The reaction apparatus was a 1L stainless steel kettle with a 3-neck glass lid equipped with an overhead mechanical stirring unit, a bearing assembly, and two 90° connectors for a nitrogen inlet. After obtaining a vacuum of 0.1 mmHg, the apparatus was placed under positive nitrogen pressure. An initial charge consisting of 385.9 grams (3.3847 moles) of ε-caprolactone, 34.1 grams (0.2943 moles) glycolide, 1.292 grams (8.18×10⁻³ moles) decyl alcohol, and 0.677 milliliters (1.354×10⁴ moles) of a 0.2M solution of tin (II) 2-ethylhexanoate in decalin was added to the kettle.

Using a high temperature oil bath, the apparatus was placed under vacuum at 40° C. for 1 hour. The system was then purged with nitrogen. The temperature of the oil bath was increased to 160° C. and stirring was initiated at 60 rpm. As the contents gained viscosity (˜25% increase in torque), the stir rate was lowered to 30 rpm. Once the torque increased by ˜25% at 30 rpm, the second charge consisting of 280 g (2.4138 moles) of glycolide and 0.338 milliliters (6.77×10⁻⁵ moles) of a 0.2M solution of tin (II) 2-ethylhexanoate in decalin was added to the kettle while stirring at 30 rpm. Stir rate was then increased to 60 rpm. Stirring was gradually decreased and stopped approximately 15 minutes after the second charge was added. The reaction was maintained at 160° C. for 12 hours after stirring was stopped.

The polymer was ground and placed under room temperature vacuum overnight. The ground polymer was poured into a 2L pear shaped glass flask and then placed on a Buchi rotavapor. After obtaining a vacuum of 0.06 mmHg, the flask and its contents were heated to 40° C. using a high temperature oil bath. After 2 hours at 40° C., the temperature of the oil bath was increased to 80° C. and maintained for 1 hour. The temperature was then increased to 110° C. and maintained for 4 hours. The flask and its contents were then allowed to cool under vacuum before removal.

The inherent viscosity using hexafluoroisopropanol as a solvent was 1.72 dl/g. Differential scanning calorimetry showed a peak at 221.2° C. with an area of 50.2 J/g.

### EXAMPLE 5

### Preparation of Indirectly Interlinked Polyethylene Glycol-35k (I-I PEG-35 k)

The preparation, isolation, purification, and characterization of I-I PEG-35k are conducted as described in U.S. Pat. No. 6,861,503 for the indirectly interlinked PEG-8k. More specifically, PEG-35k (0.001125 mole) is end-grafted with glycolide (0.2 mole) and ε-caprolactone (1.8 mole) in the presence of stannous octanoate as a catalyst (1.2×10⁻⁴ mole as a 0.2 M solution in toluene). The end-grafting is completed within 6 hours at 150° C. The end-grafted product is then interlinked with 1,6-hexamethylene diisocyanate (0.01125 mole) following a protocol similar to that described in U.S. Pat. No. 6,861,503.

### EXAMPLE 6

### Synthesis of an 20/80 (weight) Polyether/ester whereas the Polyether Component is Comprised of Poly(Ethylene Glycol)-Poly(Propylene Glycol)-Poly(Ethylene Glycol) A-B-A Block Copolymer with an Average Mₙ of 5,800 Da and the Polyester Component is Comprised of 65/35 (molar) l-Lactide/ε-Caprolactone (GB-1)

For an initial charge, poly(ethylene glycol)-block-poly(propylene glycol)-block-poly(ethylene glycol) (1.03×10⁻² moles) was added to a stainless steel reactor equipped for mechanical stirring and vacuum. The polyether was dried at 140° C. under vacuum for 45 minutes and the pressure equilibrated with dry nitrogen. For the second charge, l-lactide (1.17 moles), ε-caprolactone (0.63 moles), and tin(II) 2-ethyl hexanoate (1.20×10⁻³ moles) were added and the contents stirred to mix for 5 minutes. The temperature was increased to 165° C. and conditions maintained for 17 hours until practically complete monomer conversion was achieved. Upon completion of the polymerization, the polymer was chilled in liquid nitrogen, removed from the reactor, reduced to ˜1 in³ pieces, and dried in a vacuum oven. Residual monomer was removed by heating under reduced pressure. Characterization by gel permeation chromatography gave an Mₙ of 23 kDa, an M_{w} of 44 kDa, and an Mₚ of 41 kDa. Characterization by differential scanning calorimetry showed endotherms at 56° C. and 73° C.

Preferred embodiments of the invention have been described using specific terms and devices. The words and terms used are for illustrative purposes only. The words and terms are words and terms of description, rather than of limitation. It is to be understood that changes and variations may be made by those of ordinary skill art without departing from the spirit or scope of the invention, which is set forth in the following claims. In addition it should be understood that aspects of the various embodiments may be interchanged in whole or in part. Therefore, the spirit and scope of the appended claims should not be limited to descriptions and examples herein.

What is claimed is:

1. A biodegradable chewing gum base comprising a blend of a polypeptide and a miscible derivative thereof, the base having modulated hydrophilicity, adhesive properties, compliance, and elasticity.

2. A biodegradable chewing gum base as set forth in claim 1 wherein the polypeptide comprises a naturally occurring polypeptide.

3. A biodegradable chewing gum base as set forth in claim 1 wherein the polypeptide comprises a synthetic polypeptide.

4. A biodegradable chewing gum base as set forth in claim 2 wherein the polypeptide and the derivatives are of the prolamine type.

5. A biodegradable chewing gum base as set forth in claim 2 wherein the polypeptide comprises casein and the derivative comprises an acylated casein comprising the reaction product of casein and at least one anhydride selected from the group consisting of acetic anhydride, propionic anhydride, stearic anhydride, 2-alkyl or 2-alkenyl succinic anhydride, succinic anhydride, and itaconic anhydride.

6. A biodegradable chewing gum base as set forth in claim 3 wherein the polypeptide comprises polyaspartic acid and wherein the derivative comprises polysuccinimide partially reacted with a mono- or polyfunctional aliphatic amine.

7. A biodegradable chewing gum base as set forth in claim 6 for use as a tartar barrier agent capable of inhibiting dental tartar and plaque formation.

8. A biodegradable chewing gum base as set forth in claim 3 wherein the polypeptide comprises polyaspartic acid and the derivative comprises polysuccinimide partially reacted with water and an alkylamine and further reacted with calcium hydroxide.

9. A biodegradable chewing gum base comprising a polyether ester, the base having modulated hydrophilicity, adhesive properties, compliance, and elasticity.

10. A biodegradable chewing gum base as set forth in claim 9 wherein the polyether ester comprises an polyethylene glycol end-grafted with at least one cyclic monomer selected from the group consisting of dl-lactide, l-lactide, glycolide, trimethylene carbonate, ε-caprolactone, p-dioxanone, 1,5-dioxepan-2-one and a morpholinedione.

11. A biodegradable chewing gum base as set forth in claim 9 wherein the polyether ester comprises the reaction product of a polyethylene glycol and a dialkyl oxalate in the presence of at least one alkane diol having the formula HO(CH₂)ₙOH where n=2 to 12.

12. A biodegradable chewing gum base as set forth in claim 9 wherein the polyether-ester comprises a block copolymer of polyethylene glycol and polypropylene glycol end-grafted with at least one cyclic monomer selected from the group consisting of dl-lactide, l-lactide, trimethylene carbonate, ε-caprolactone, glycolide, p-dioxanone, 1,5-dioxepan-2-one, and a morpholinedione.

13. A biodegradable chewing gum base as set forth in claim 12 wherein the polyether-ester has at least one hydroxyl end-group per chain converted to a free radically polymerizable group through reaction with itaconic anhydride.

14. A biodegradable chewing gum base comprising a crystalline segmented copolyester, the base having modulated hydrophilicity, adhesive properties, compliance, and elasticity, and exhibiting a first melting endotherm below about 60° C. and a second melting endotherm below about 220° C. with an overall heat of fusion of less than about 70 J/g.

15. A biodegradable chewing gum base as set forth in claim 14 wherein the copolyester has at least one hydroxyl group per chain converted to a free radically polymerizable group through reaction with itaconic anhydride.

16. A biodegradable chewing gum base as set forth in claim 14 wherein the copolyester has at least one hydroxyl group per chain that is interlinked with a polyethylene glycol by an interlinking agent comprising lysine diisocyanate.

17. A biodegradable chewing gum base comprising a polysaccharide and a miscible derivative thereof, the base having modulated hydrophilicity, compliance, adhesive properties, and elasticity.

18. A biodegradable chewing gum base as set forth in claim 17 wherein the polysaccharide comprises chitosan and the derivative comprises an acylated chitosan comprising the reaction product of chitosan and at least one anhydride selected from the group consisting of acetic anhydride, propionic anhydride, stearic anhydride, 2-alkyl or 2-alkenyl succinic anhydride, succinic anhydride, and itaconic anhydride.
